(19) United States
(12) Patent Application Publication
(10) Pub. No.: US 2002/0164500 A1
(43) Pub. Date: Nov. 7, 2002

(54) Roll made of media in strip or tape form with an identification coding and process for production thereof

(75) Inventor: Bernd Scholtysik, Munich (DE)

Correspondence Address: GREENBLUM & BERNSTEIN, P.L.C., 1941 ROLAND CLARKE PLACE, RESTON, VA, 20191, US

(73) Assignee: EMTEC MAGNETICS GmbH, Ludwigshafen (DE)

(21) Appl. No.: 10/138,491

(22) Filed: May 6, 2002

(30) Foreign Application Priority Data
May 7, 2001 (DE) 101 22 105.3

(51) Int. Cl. G11B 5/78

(52) U.S. Cl. 428/694 R

(57) ABSTRACT

Roll made of media in one of strip or tape form and process for producing the roll, the roll including a hub with a data recording medium in one of strip or tape form wound thereon, the data recording medium having a tape end fastened on a roll of the data recording medium by way of a printed adhesive strip. A sealing element of the roll is formed by an adhesive strip having an adhesive underside. The adhesive strip overlaps the tape end with its one end by a first length and overlaps a label strip with its other end by a second length. The adhesive strip is adhesively attached to the upper side of the label strip. The adhesive strip is adhesively bonded to the outer circumference of the roll between two overlapping regions in a region with a third length. The label strip is provided on its upper side with an identification coding.

### CROSS-REFERENCE TO RELATED APPLICATIONS

The present application claims priority under 35 U.S.C. §119 of German Patent Application 10122105.3, filed May 7, 2001, the disclosure of which is expressly incorporated by reference herein in its entirety.

### BACKGROUND OF THE INVENTION

1. Field of the Invention

The invention relates to a roll made up of media in strip or tape form, in particular magnetic data recording media in tape form, with an identification coding and to a process for its production.

2. Discussion of Background Information

Rolls made up of media in strip or tape form, in particular magnetic data recording media, generally comprise a hub on which the recording medium, which has been slit to a usable width, is wound up, often in a length of several thousands of meters. The free end of the recording medium is fixed on the outermost turn of the roll. Furthermore, on the outside of the roll there is normally a coding label, which contains a product coding or a product batch code.

Magnetic recording media comprise substantially a base film of plastic and a magnetizable coating applied to it by known coating methods. These magnetic recording media are usually produced in a much greater width than the width necessary for the application. After coating, the recording medium is wound up to form what are known as semifinished rolls, the length of which is many times the later useful length.

In a further processing step, the semifinished rolls are cut by what are known as slitting machines into the tape widths necessary for the application, for example ½″ (12.7 mm) for video cassettes or 3.81 mm for compact audio cassettes.

The basic construction of a slitting machine of this type is represented in FIG. 1. The machine substantially comprises an unrolling station (100) for wide semifinished rolls, a cutting and splicing table (200), a slitting device (300), a tape spreader (400) for individually separating the tapes slit to the usable width, a winding-up station (500) for winding up the individual slit tapes and a plurality of guiding and driving rollers (600) for transporting the wide, unslit semifinished web (HFB) and the slit individual tapes (EB) of the usable width.

When the roll of tape has been wound up to a predetermined length at the winding-up station (500), the slitting operation is interrupted and the wide semifinished web (HFB) is cut through at the cutting table (200) transversely to the longitudinal direction of the tape. Subsequently, the two tapes abutting each other at the cutting table are joined together again by adhesive tape stuck transversely over the web width. The slitting operation is then continued, the transversely attached adhesive tape running through the slitting device (300) and, as it does so, likewise being cut to the width of the slit magnetic tape strips, creating in each tape strip a splice which joins the end of the first tape (3) to the beginning of the next-following tape (4), as shown in FIG. 2. When the splice has reached the roll of tape (1) wound up on the hub (2), the slitting operation is interrupted again and the splices are opened, in that the adhesive strips (5) are pulled off from the next-following tape (4) by pulling on the non-adhering grips (6) of the adhesive strip. The sticky region (5.1) of the adhesive strip (5) exposed as a result is then securely attached at the outside of the roll of tape (1) and the roll of tape is sealed ready for sale, with reference to FIG. 3. If the roll of tape has to be opened again later for further processing, this is easily possible by pulling on the grip (6) of the adhesive strip (5).

For marking the roll of tape with a product designation or a product batch code, the adhesive strip (5) may be provided with printing (7). However, this presupposes that the adhesive strip (5) is of an adequate size. Furthermore, for this purpose, the adhesive strip (5) must be provided with a surface finish suitable for the chosen printing process, for example needle printers or thermal transfer printers. The requirements imposed on the adhesive strip in this process, with respect to width, non-adhesive grip (6), printable surface, require specially produced adhesive strips, which are relatively expensive as a result.

The relatively great width of the adhesive strip required by the printing also has the disadvantage that, during slitting in the slitting device (300), the circular cutters used for the slitting are in contact with the adhesive strip for longer periods of time, and there is consequently increased deositing of adhesive on the cutters, which reduces the service life of the cutters and impairs the quality of the slit magnetic tape.

In the case of another customary process, the joint between the first tape and the next-following tape is produced on the cutting and splicing table (200) by forming what is known as an “open” splice (5.2), that is to say there is a sticky region (5.2) of the adhesive strip (5) between the first tape (3) and the next-following tape (4). When the “open” splice (5.2) arrives at the roll of tape (1) after the slitting, the roll of tape is simply sealed by the winding-up operation, and the beginning of the next-following tape (4) is cut off transversely behind the adhesive strip (5). The remainder of the next-following tape (4) thereby remaining on the roll serves in this case as a grip for opening the roll of tape, which is shown in FIG. 4.

It is also customary to use the adhesive strip (5) only for sealing the roll of tape and to use a separate coding label (8) with printing (9), which is fastened by separate adhesive strips (10.1, 10.2) on the roll of tape (1), as shown in FIG. 5.

The process with the “open” splice (5.2) has the disadvantage for magnetic tapes with high quality requirements that the “open” splice touches the transport rollers (600) and the cutting blades as it is transported through the slitting machine, whereby deposits of adhesive can occur on machine parts, impairing the quality of the magnetic tape produced.

### SUMMARY OF THE INVENTION

According to the invention, there is provided a roll made up of media in strip or tape form, in particular magnetic data recording media, which does not have the described disadvantages of the prior art, in particular to produce an adhesive strip with identification coding which reduces the production costs and can be easily attached to the roll of tape.

According to the invention, a data recording medium in tape form is wound on a hub, the sealing element of the outermost wound layer on the roll of tape being designed in such a way that a simple, narrow adhesive tape can be used for both sealing the roll of tape and fastening a coding label in such a way that this coding label can be used as a grip for opening the sealing adhesive strip of the roll of tape.

According to another aspect of the invention, there is provided a process for producing such a roll of tape, with the intention that no “open” splice is to be transported through the slitting machine.

According to the above-mentioned aspect of the invention, a process for producing the roll of tape described above, the sealing element of the roll of tape, including the coding label, are formed as the joint between the end of a first semifinished web and the beginning of a further semifinished web running through a slitting machine, the joint comprising an adhesive strip and a printed label strip, the adhesive strip fixing the label strip in such a way that the latter can be used as a grip for opening the finished roll of tape.

According to the invention, a roll made of media in one of strip or tape form, comprises a hub with a data recording medium in one of strip or tape form wound thereon. The data recording medium has a tape end fastened on a roll of the data recording medium by way of a printed adhesive strip, wherein a sealing element of the roll is formed by an adhesive strip having an adhesive underside. The adhesive strip overlaps the tape end with its one end by a first length and overlaps a label strip with its other end by a second length. The adhesive strip is adhesively attached to the upper side of the label strip. The adhesive strip is adhesively bonded to the outer circumference of the roll between two overlapping regions in a region with a third length. The label strip is provided on its upper side with an identification coding.

According to a further aspect of the invention, the media may comprise a magnetic data recording media in tape form. The label strip may comprise one of paper or a printable film. The label strip may be printed on by way of one of a needle or thermal transfer printer. The adhesive strip may be colored.

The roll made of media in one of strip or tape form according to the invention comprises a hub with a data recording medium in strip or tape form wound thereon and a sealing element for the roll. A wide semifinished web is slit by a slitting device into individual tapes of a usable width and is subsequently fed to a winding-up station. The tensioned semifinished web is lowered onto a transverse cutting device when a predetermined length of the rolls of tape is reached, the transverse cutting device being arranged between an unwinding station and the slitting device, and being transversely cut, the two ends of the web being positionally fixed. A label strip, the length of which is at least equal to the web width of the semifinished roll, is printed with identification codings in a manner such that the line spacing of the printing corresponds to a width of the individual tapes, and being placed onto a next-following web in such a way that it is at a small distance from a cut line.

According to the invention, the adhesive strip may have a length corresponding approximately to the web width of the semifinished rolls, and may be lowered with its adhesive underside onto the web, approximately centrally with respect to a cut location, in such a way that it has both an overlap of a first length with a first semifinished web and an overlap of a second length with the label strip and also has ajoint of a third length with a second semifinished web. The joined semifinished webs may be passed through the slitting device. According to the invention, when the joint of the semifinished webs reaches the winding-up station, with the web stopped, the joint is opened by pulling on the label strip, and the then-free sticky region of a longitudinally cut adhesive strip between the web end and the label may be adhesively attached to the outer layer of the roll.

According to a further aspect of the invention, a roll made of media in one of strip or tape form, comprises a hub with a data recording medium in strip or tape form wound thereon and a sealing element for the roll. A wide semifinished web is slit by a slitting device into individual tapes of a usable width and is subsequently fed to a winding-up station. The tensioned semifinished web is lowered onto a transverse cutting device when a predetermined length of the rolls of tape is reached, the transverse cutting device being arranged between an unwinding station and the slitting device, and being transversely cut, the two ends of the web being positionally fixed. A label strip, the length of which is at least equal to the web width of the semifinished roll, is printed with identification codings in a manner such that the line spacing of the printing corresponds to a width of the individual tapes, and being placed onto a next-following web in such a way that it is at a small distance from a cut line. The adhesive strip may have a length corresponding approximately to the web width of the semifinished rolls, and is lowered with its adhesive underside onto the web, approximately centrally with respect to a cut location, in such a way that it has both an overlap of a first length with a first semifinished web and an overlap of a second length with the label strip and also has a joint of a third length with a second semifinished web. The joined semifinished webs may be passed through the slitting device. When the joint of the semifinished webs reaches the winding-up station, with the web stopped, the joint may be opened by pulling on the label strip, and the then-free sticky region of a longitudinally cut adhesive strip between the web end and the label may be adhesively attached to the outer layer of the roll.

According to another aspect of the invention, a process for producing a roll made of media in one of strip or tape form, on a hub with a data recording medium in one of strip or tape form wound thereon, including a sealing element for the roll, comprises passing a wide semifinished web from an unrolling station into a slitting device, slitting, by using a device, the wide semifinished web into individual tapes of a usable width, feeding the individual tapes to a winding-up station, lowering the semifinished web onto a transverse cutting device when a predetermined length of the roll is reached, the cutting device being arranged between the unrolling station and the slitting device, cutting transversely the semifinished web, positionally fixing two web ends, printing with identification codings a label strip, the length of which is at least equal to a web width of a semifinished roll, the printing being done in a manner such that a line spacing of the printing corresponds to a width of the individual tapes, placing the label strip onto the next-following web in a manner that it is at a small distance from a cut line, lowering the adhesive strip, the length of which corresponds approximately to the web width of the semifinished rolls, with its adhesive underside onto the web, approximately centrally with respect to a cut location, in a manner that it has both an overlap of a first length with a first semifinished web and an overlap of a second length with the label strip and also has a joint of a third length with a second semifinished web, passing the semifinished webs joined in this manner through the slitting device, opening a joint of semifinished webs when the webs reach a winding-up station, with the web stopped, the joint being opened by pulling on the label strip, and adhesively attaching a free sticky region of longitudinally cut adhesive strip between a tape end and the label strip to an outer layer of the roll.

Moreover, according to the invention, a length L of the label strip may be slightly greater than a width of the semifinished roll. The media may comprise a magnetic data recording media in tape form.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting exemplary embodiments of the present invention, in which like reference numerals represent similar parts throughout the several views of the drawings, and wherein:

FIG. 1 shows a schematic representation of a slitting machine;

FIG. 2 shows a schematic representation of a splice according to the prior art, shortly before reaching the roll of tape;

FIG. 3 shows a schematic representation of a finished roll of tape according to the prior art;

FIG. 4 shows a schematic representation of a roll of tape according to the prior art with what is known as an open splice;

FIG. 5 shows a schematic representation of a roll of tape according to the prior art with a separately fastened coding label;

FIG. 6 shows a schematic representation of a roll of tape according to the invention with a coding label;

FIG. 7 shows a schematic side view of a cutting table for the process according to the invention for producing the joint of the semifinished webs;

FIG. 8 shows a corresponding plan view.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

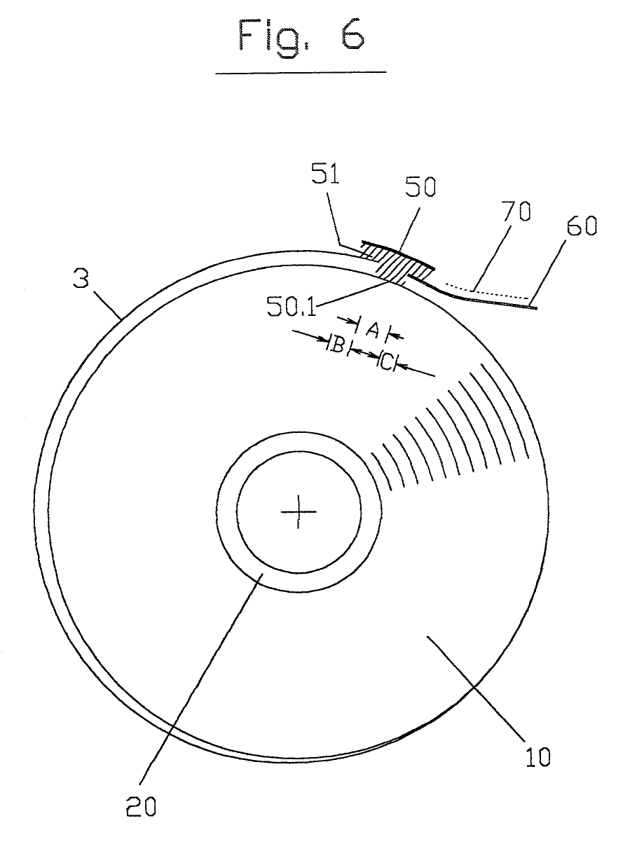

A roll of tape according to the invention is schematically represented in FIG. 6. The sealing element of the roll of tape (10) wound onto the hub (20) comprises a narrow adhesive strip (50) with an adhesive underside (51), the adhesive strip overlapping on its one side the end of the last wound layer (3) of the roll (10) by a short piece, for instance in the range of a few millimeters. On its other end, the adhesive strip (50) overlaps by a few millimeters a label (60) printed with the identification coding (70) on its upper side, the adhesive strip adhering to the upper side of the label (60). Between the two overlapping regions mentioned, the adhesive strip (50) is adhesively bonded to the outer layer of the roll of tape (10) in a region (50.1). The overall length of the adhesive strip (50) is made up of the two overlapping regions with respect to the outermost layer of tape (3) and the label (60) and the length of the adhesive bond (50.1) with the outer layer of the roll of tape (10). In the case of this configuration of the roll of tape (10) according to the invention, the label (60) also performs the function of the grip for opening the roll of tape during the further processing of the tape, for example transferring it into a cassette. The adhesive strip (50) may be made in different colors for distinguishing the grade of tape respectively used.

The advantage of the configuration according to the invention is that the adhesive strip is narrow and does not require a printable surface and that no special get-up with an adhesive-free grip is necessary. Therefore, simple commercially available adhesive-tape roll stock can be used as the adhesive strip—expensive customized fabrications are not required. The label may comprise paper or a plastic film. Altogether, the solution according to the invention is very inexpensive. Since the adhesive strip (50) is narrow, only a short distance is cut through the adhesive by the cutters of the slitting machine, thereby reducing quality-impairing deposits of adhesive on the slitting cutters.

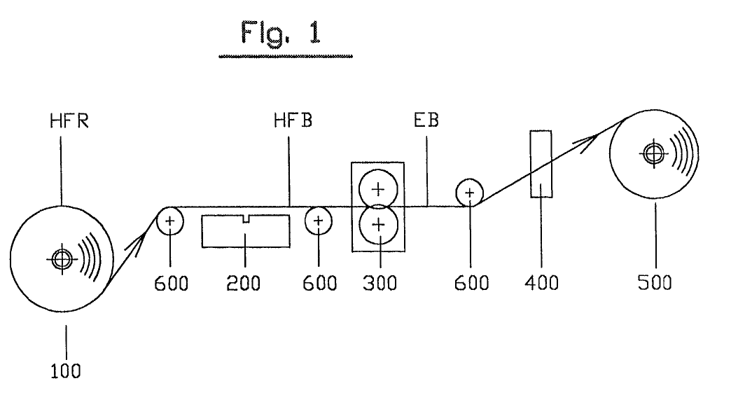

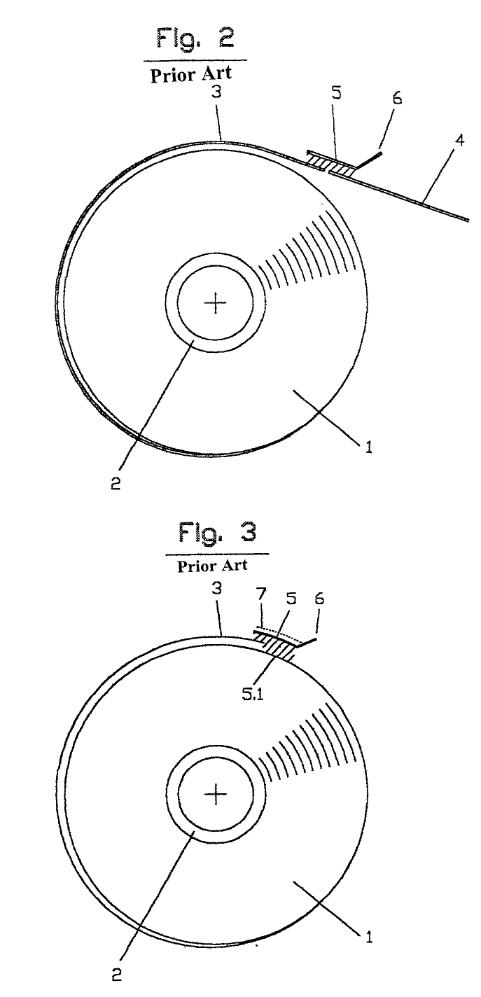

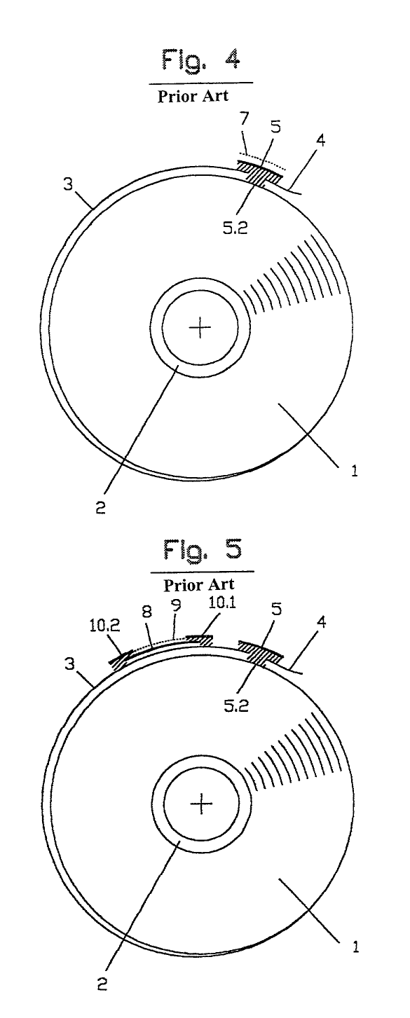

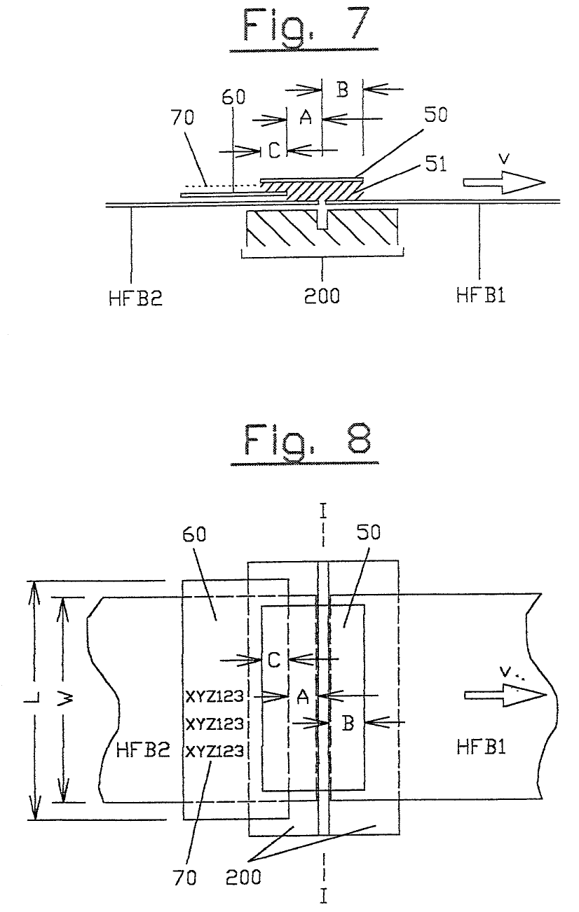

A process for producing a roll of tape (10) according to the invention is now described with reference to FIGS. 1, 6, 7 and 8.

As can be seen from FIG. 1, a semifinished roll (HFR), stored in the unrolling station (100), is unrolled and passed initially without contact over the cutting table (200) by guiding rollers (600) and reaches the slitting device (300). The slit tapes produced as a result are fanned out in the tape spreader (400) and fed to the winding-up station (500), where they are wound up to form rolls of tape. When the rolls of tape have reached a predetermined length at the winding-up station, the slitting operation is interrupted and the semifinished web is lowered onto the cutting table (200) by slackening of the web tension. The cutting table has a porous surface, allowing the semifinished web to be sucked onto the suction table and fixed as a result. Subsequently, the semifinished web is cut through along the line I-I transversely to the running direction (v) of the web. On the suction table, the two semifinished webs HFB1 and HFB2 are consequently now fixed directly next to each other.

The label strip (60) is printed using a suitable printing device, for example a needle printer or thermal transfer printer, with the identification coding (70) transversely to its longitudinal direction, the printing taking place with a line spacing which corresponds to the width of the tapes to be slit, that is for example 3.81 mm for compact audio tapes. The printed label strip is then placed onto the semifinished web HFB2 extending toward the unrolling station (100) in such a way that it is at a distance A of a few millimeters from the cut line (I-I). In order that the label strip (60) remain fixed in its position, the length L of the label strip is favorably chosen to be slightly greater than the width W of the semifinished web, so that the label strip can also be sucked onto the cutting table (200) at both its ends. Subsequently, the adhesive strip (50) is attached in such a way that it has both an overlap with the semifinished web HFB1 of the length B and an overlap with the label strip (60) of the length C. As a result, the adhesive strip (50) also has a joint with the semifinished web HFB2 of the length A.

In this way, a joint is produced between the two semifinished webs HFB1 and HFB2 without an “open” splice and, furthermore, the label strip (60) is fixed just behind the joint of the two semifinished webs HFB1 and HFB2.

When the joint produced in this way between the two semifinished webs subsequently runs through the slitting machine (300), corresponding joints are created on each individual tape strip in the width of the slit tapes. When these joints in the individual tapes finally arrive at the winding-up station (500), the cutting and winding operation is interrupted. At the individual roll of tape (10), the joint in the tape can then be opened by pulling on the label strip (60), serving as a grip, and after that the longitudinally cut adhesive strip (50) can be adhesively attached on the outer layer of the roll of tape (10) by the sticky region (50.1) which is free between the web end (3) and the label strip (60). The roll of tape is consequently in a state in which it is ready for sale. During the further processing of the rolls of tape (10), they can be opened again with the aid of the label strip (60), serving as a grip, the identification coding (70) also being printed on the grip.

With the production process described, the splice and identification coding of the rolls of tape according to the invention as shown in FIG. 6 can consequently be produced with simple starting materials, that is the adhesive strip (50) and label strip (60).

Use of the invention described is not restricted to rolls made up of magnetic data recording media, but can also be advantageously extended to other media in strip or tape form.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A roll made of media in one of strip or tape form, comprising:
a hub with a data recording medium in one of strip or tape form wound thereon;
said data recording medium having a tape end fastened on a roll of the data recording medium by way of a printed adhesive strip,
wherein a sealing element of the roll is formed by an adhesive strip having an adhesive underside;
the adhesive strip overlapping the tape end with its one end by a first length and overlapping a label strip with its other end by a second length;
the adhesive strip being adhesively attached to the upper side of the label strip;
the adhesive strip being adhesively bonded to the outer circumference of the roll between two overlapping regions in a region with a third length; and
the label strip being provided on its upper side with an identification coding.

2. The roll according to claim 1, wherein the media comprises a magnetic data recording media in tape form.

3. The roll according to claim 1, wherein the label strip comprises one of paper or a printable film.

4. The roll according to claim 1, wherein the label strip is printed on by way of one of a needle or thermal transfer printer.

5. The roll according to claim 1, wherein the adhesive strip is colored.

6. A roll made of media in one of strip or tape form, comprising a hub with a data recording medium in strip or tape form wound thereon;
a sealing element for the roll;
a wide semifinished web being slit by a slitting device into individual tapes of a usable width and being subsequently fed to a winding-up station;
the tensioned semifinished web being lowered onto a transverse cutting device when a predetermined length of the rolls of tape is reached, said transverse cutting device being arranged between an unwinding station and the slitting device, and being transversely cut, the two ends of the web being positionally fixed;
a label strip, the length of which is at least equal to the web width of the semifinished roll, said label strip being printed with identification codings in a manner such that the line spacing of the printing corresponds to a width of the individual tapes, and being placed onto a next-following web in such a way that it is at a small distance from a cut line.

7. The roll according to claim 6, wherein the adhesive strip has a length corresponding approximately to the web width of the semifinished rolls, and is lowered with its adhesive underside onto the web, approximately centrally with respect to a cut location, in such a way that it has both an overlap of a first length with a first semifinished web and an overlap of a second length with the label strip and also has a joint of a third length with a second semifinished web.

8. The roll according to claim 7, wherein the joined semifinished webs are passed through the slitting device.

9. The roll according to claim 8, wherein when the joint of said semifinished webs reaches said winding-up station, with the web stopped, the joint is opened by pulling on the label strip, and the then-free sticky region of a longitudinally cut adhesive strip between the web end and the label is adhesively attached to the outer layer of the roll.

10. A roll made of media in one of strip or tape form, comprising a hub with a data recording medium in strip or tape form wound thereon;
a sealing element for the roll;
a wide semifinished web being slit by a slitting device into individual tapes of a usable width and being subsequently fed to a winding-up station;
the tensioned semifinished web being lowered onto a transverse cutting device when a predetermined length of the rolls of tape is reached, said transverse cutting device being arranged between an unwinding station and the slitting device, and being transversely cut, the two ends of the web being positionally fixed;
a label strip, the length of which is at least equal to the web width of the semifinished roll, said label strip being printed with identification codings in a manner such that the line spacing of the printing corresponds to a width of the individual tapes, and being placed onto a next-following web in such a way that it is at a small distance from a cut line,
wherein the adhesive strip has a length corresponding approximately to the web width of the semifinished rolls, and is lowered with its adhesive underside onto the web, approximately centrally with respect to a cut location, in such a way that it has both an overlap of a first length with a first semifinished web and an overlap of a second length with the label strip and also has a joint of a third length with a second semifinished web,
wherein the joined semifinished webs are passed through the slitting device,
wherein when the joint of said semifinished webs reaches said winding-up station, with the web stopped, the joint is opened by pulling on the label strip, and the then-free sticky region of a longitudinally cut adhesive strip between the web end and the label is adhesively attached to the outer layer of the roll.

11. A process for producing a roll made of media in one of strip or tape form, on a hub with a data recording medium in one of strip or tape form wound thereon, including a sealing element for the roll, said process comprising:
passing a wide semifinished web from an unrolling station into a slitting device;
slitting, by using a device, said wide semifinished web into individual tapes of a usable width;
feeding said individual tapes to a winding-up station;
lowering the semifinished web onto a transverse cutting device when a predetermined length of the roll is reached, said cutting device being arranged between the unrolling station and the slitting device;
cutting transversely said semifinished web;
positionally fixing two web ends;
printing with identification codings a label strip, the length of which is at least equal to a web width of a semifinished roll, the printing being done in a manner such that a line spacing of the printing corresponds to a width of the individual tapes;
placing the label strip onto the next-following web in a manner that it is at a small distance from a cut line;
lowering the adhesive strip, the length of which corresponds approximately to the web width of the semifinished rolls, with its adhesive underside onto the web, approximately centrally with respect to a cut location, in a manner that it has both an overlap of a first length with a first semifinished web and an overlap of a second length with the label strip and also has a joint of a third length with a second semifinished web;
passing the semifinished webs joined in this manner through the slitting device;
opening ajoint of semifinished webs when the webs reach a winding-up station, with the web stopped, the joint being opened by pulling on the label strip;
adhesively attaching a free sticky region of longitudinally cut adhesive strip between a tape end and the label strip to an outer layer of the roll.

12. The process according to claim 11, wherein a length L of the label strip is slightly greater than a width of the semifinished roll.

13. The process according to claim 12, wherein the media comprises a magnetic data recording media in tape form.
